(19) United States
(12) Patent Application Publication
(10) Pub. No.: US 2016/0086258 A1
(43) Pub. Date: Mar. 24, 2016

(54) CUSTOMIZABLE THREE DIMENSIONAL MODELS

(71) Applicant: Autodesk, Inc., San Rafael, CA (US)

(72) Inventors: Christopher C. Romes, West Linn, OR (US); Brandon Willets Cole, Kennesaw, GA (US)

(21) Appl. No.: 14/495,120

(22) Filed: Sep. 24, 2014

(51) Int. Cl. G06Q 30/06; B29C 67/00

(52) U.S. Cl. CPC G06Q 30/0641; B29C 67/0088

(57) ABSTRACT

Methods, systems, and apparatus, including medium-encoded computer program products, facilitate creation and use of customizable three dimensional models. In one aspect, a method includes receiving input specifying one or more controls that modify geometry of a three dimensional (3D) model of an object; converting the 3D model of the object and the one or more specified controls into a program that runs in a publicly available runtime environment to provide a model interface to change the 3D model in accordance with the one or more specified controls when the program is run in the publicly available runtime environment; and publishing the program to an online marketplace for 3D models available for 3D printing.

### BACKGROUND

This specification relates to three dimensional (3D) modeling programs, such as computer-aided design (CAD) applications used with 3D printing.

CAD software has been developed and used to generate two dimensional (2D) and 3D representations of objects. Such 3D representations of objects have employed various modeling techniques to represent the 3D object. In general, 3D models can be divided into two categories: (1) solid models that represent volumes of the object, and (2) shell models that represent the boundaries between solid and non-solid parts of the 3D object. In either case, CAD software is used to design and modify the 3D models. Such CAD software can be purchased for installation on individual computers or for access via a private network or a public network (e.g., the Internet).

### SUMMARY

This specification describes technologies relating to 3D modeling programs, such as CAD applications used with 3D printing.

In general, one or more aspects of the subject matter described in this specification can be embodied in one or more methods that include receiving input specifying one or more controls that modify geometry of a three dimensional (3D) model of an object; converting the 3D model of the object and the one or more specified controls into a program that runs in a publicly available runtime environment to provide a model interface to change the 3D model in accordance with the one or more specified controls when the program is run in the publicly available runtime environment; and publishing the program to an online marketplace for 3D models available for 3D printing. Other embodiments of this aspect include corresponding systems, apparatus, and computer program products.

For example, one or more additional aspects of the subject matter described in this specification can be embodied in one or more systems that include one or more computer storage media having instructions stored thereon; and one or more data processing apparatus configured to execute the instructions to perform operations including (i) receiving input specifying one or more controls that modify geometry of a 3D model of an object, (ii) converting the 3D model of the object and the one or more specified controls into a program that runs in a publicly available runtime environment to provide a model interface to change the 3D model in accordance with the one or more specified controls when the program is run in the publicly available runtime environment, and (iii) publishing the program to an online marketplace for 3D models available for 3D printing.

The online marketplace can include a web server system, the publicly available runtime environment can include a web browser, and the program can include scripting code. The program can include the 3D model and the one or more specified controls of the model interface, and the online marketplace can include: a 3D model ratings interface through which users can provide feedback on the 3D model of the program; and a 3D printing interface through which users can request an order for the object of the 3D model from a 3D printing service provider after modification using the one or more specified controls.

The 3D printing interface can include a 3D model purchasing interface through which users can pay for the program, the order, or both. An available change to the 3D model through the model interface can include an addition to the 3D model, and the online marketplace for 3D models can allow republication of the program with the addition made thereto. In addition, the receiving can include receiving input specifying one or more additional controls that modify one or more parameters of one or more components of the 3D model of the object, and the converting can include converting the one or more additional controls for the program to provide the model interface to change the 3D model in accordance with the one or more additional controls when the program is run in the publicly available runtime environment.

The methods performed by one or more data processing apparatus can include: determining a range of possible changes made available through the model interface; and analyzing the range of possible changes to identify 3D printing issues. The determining and the analyzing can be performed before finalizing publication of the program to the online marketplace. Moreover, determining and the analyzing can be performed while receiving the input specifying the one or more controls.

Particular embodiments of the subject matter described in this specification can be implemented to realize one or more of the following advantages. Customizable 3D models can be readily created and shared with others in a manner that facilitates the growth of a 3D design and printing community. Users of an online marketplace for 3D models can readily find, review, modify, and print 3D models. The systems and techniques employed can facilitate use by creative people that may not have the skills or experience needed to design custom 3D models using traditional CAD software. Moreover, the systems and techniques also may facilitate the creation of models (digital and solid) through the use of automation or other computer means, such as macros or other API settings, and adoption and ease of use may also improve the skills of those using systems and techniques described.

The details of one or more embodiments of the subject matter described in this specification are set forth in the accompanying drawings and the description below. Other features, aspects, and advantages of the invention will become apparent from the description, the drawings, and the claims.

### BRIEF DESCRIPTION OF THE DRAWINGS

FIG. 1 shows an example of a system to provide customizable 3D models and 3D printing.

FIG. 2 shows an example of a flowchart of a process to provide customizable 3D models for 3D printing.

FIGS. 3A and 3B show examples of user interfaces for a customizable 3D model.

FIG. 4A shows an example of a JavaScript software architecture.

FIG. 4B shows an example of code workflow.

FIG. 5 shows an example of a platform architecture for an online marketplace.

FIG. 6 is a schematic diagram of a computer system, which can be programmed as a client or as a server.

Like reference numbers and designations in the various drawings indicate like elements.

### DETAILED DESCRIPTION

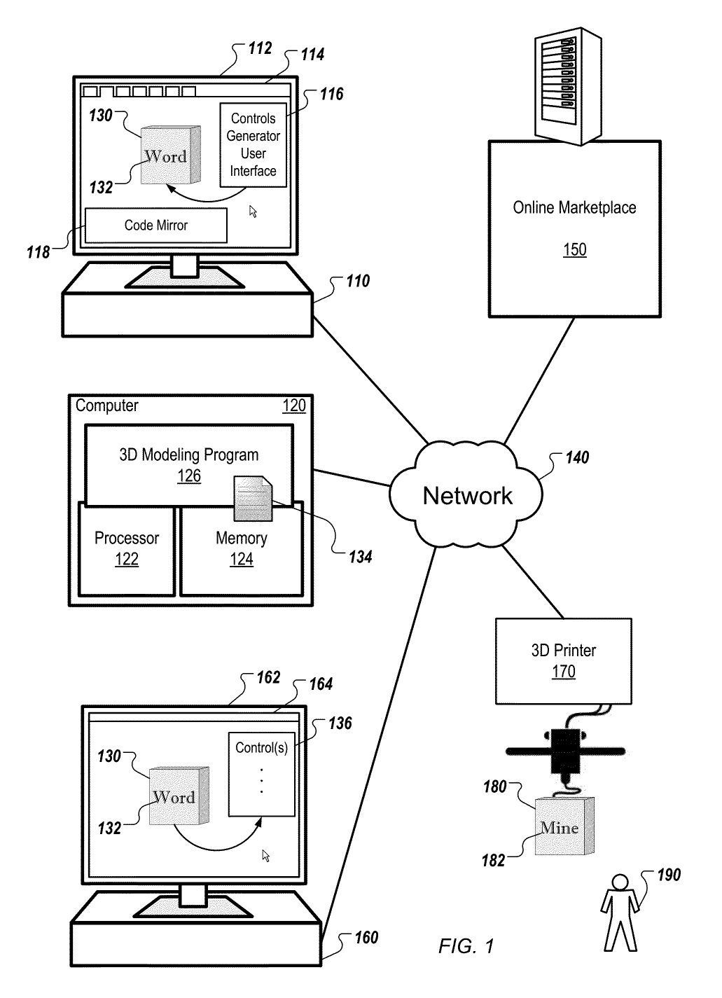

FIG. 1 shows an example of a system to provide customizable 3D models and 3D printing. Computers 110, 160 can be connected to a network 140, which can be a private network, a public network, a virtual private network, etc. Each such computer can include components, such as shown for computer 120, which include a processor 122 and a memory 124. The processor 122 can be one or more hardware processors, which can each include multiple processor cores. The memory 124 can include both volatile and non-volatile memory, such as Random Access Memory (RAM) and Flash RAM. The computer 120 can include various types of computer storage media and devices, which can include the memory 124, to store instructions of programs that run on the processor 122.

Such programs can include a three dimensional (3D) modeling program 126, which can run locally on computer 110 or remotely on computer 120 (e.g., in a server system accessible by the computer 110 via the network 140). The 3D modeling program 126 presents a user interface (UI) 114 on a display 112 of the computer 110 (note that while shown as separate devices in FIG. 1, the display 112 can also be integrated with the computer 110, such as in a tablet computer). A user 190 at the computer 110 can thus interact with the 3D modeling program 126 to create a 3D model 130, e.g., a boundary representation model of a solid object. This can be done using known graphical user interface tools, and a code mirror 118 of the UI 114 can concurrently display underlying code that generates the 3D model. The code mirror 118 can also provide direct editing functions for the underlying code. Moreover, the underlying code can be specific to the program 126 or be computer program code that conforms to a standard.

The UI 114 includes a controls generator UI 116 for use in adding one or more controls to the 3D model 130. Such controls can include controls to modify parameters (e.g., size or orientation) of a model component or group of components and can also include controls that modify the geometry of the 3D model 130. Such geometry modification controls can add entirely new components to the model 130 (e.g., one or more model components to be imported from an outside source) or define components that change the details of the model geometry once further input is provided (e.g., a word component that allows later selection of a 3D font type, which thus causes regeneration of the surfaces or volumes of the model 130). In the example shown, a word component 132 is added to the model 130 using the controls generator UI 116.

Once the user at the computer 110 completes the design of the model 130 of an object, with one or more specified controls for one or more re-definable components 132, the 3D modeling program 126 can convert the 3D model 130 of the object and the one or more specified controls into a program 134 that runs in a publicly available runtime environment. For example, the model and control(s) can be converted into scripting code (such as JavaScript) that can run in a web browser UI 164 on a display 162 of another computer 160 (note that display 162 can likewise be integrated into its corresponding computer 160, such as in a smart phone). The program 134 can then be published to an online marketplace 150 for 3D models available for 3D printing. The online marketplace 150 can be a web site hosted on a server system. Moreover, the online marketplace 150 can be separate from a computer 120 providing the 3D modeling program 126, or the computer 120 can be included in the same server system providing the online marketplace 150.

Once published to the marketplace 150, the program 134 (and thus its model 130) can be made available for downloading and/or purchase by another user 190 at a computer 160. When the program 134 is run on the computer 160 in the runtime environment (e.g., a web browser program) the model 130 is generated and displayed in the UI 164. In addition, one or more controls 136 are generated by running the program 134, and those controls 136 allow the user at the computer 160 to modify the geometry of the model 130. In the example shown, the user can enter new text to display (“Mine”) to replace “Word” in the model in a 3D font. When this is done, the model is regenerated with the new geometry and can then be made available for republishing or 3D printing on a 3D printer 170.

The 3D printer 170 can be directly connected to the computer 160 or accessible through a network 140. In addition, access to the 3D printer can be provided through the online marketplace 150. For example, the marketplace 150 can include functionality for ordering a 3D print from one or more 3D printing service providers. In any case, the user 190 can obtain a physical object 180 printed from the model 130 with her individualized design details 182 added.

Although shown in FIG. 1 as a single document, the program 134 is an electronic document, which need not correspond to a single file. In some implementations, the program 134 can be more than one file downloaded to the computer 160. In addition, in some implementations, not all the code of the program 134 needs to be resident on the computer 160 at one time. For example, one or more files of the program 134 can include references to code located remotely from the computer 160, e.g., at the marketplace servers. In some implementations, all of the code of the program 134 runs on a local processor of the computer 160. In some implementations, some of the code used to generate the model 130 on the computer 160 runs remotely. For example, in a JavaScript implementation, some code can run on a client computer, while some code can run on a server computer, and the location of program operation (client versus server) for various parts of the code can be determined at runtime since the module of program code can be design to run both as client-side code and server-side code, as needed.

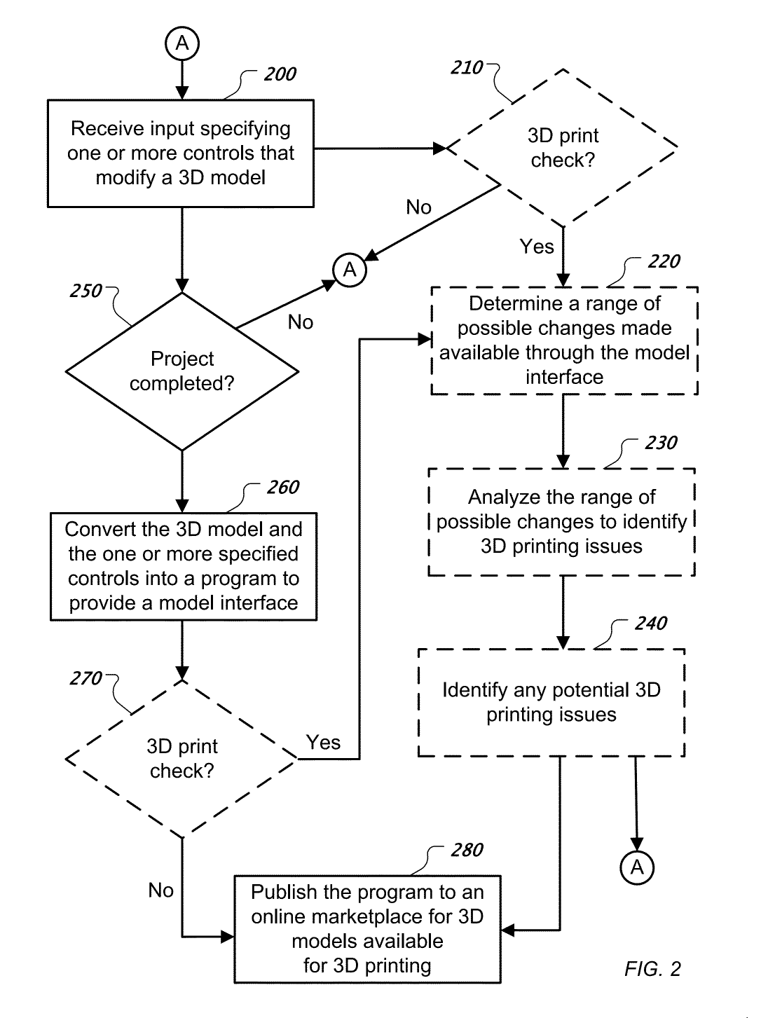

FIG. 2 shows an example of a flowchart of a process to provide customizable 3D models for 3D printing. Input is received 200 (e.g., through UI 116) where the input specifies one or more controls that modify geometry of a 3D model of an object. Until a user indicates that the current project is completed 250, such input can continue to be received 200. These inputs can modify previously created controls or create new controls for the 3D model. The additional controls can include one or more additional controls that modify geometry of 3D model of an object, as well as one or more additional controls that modify one or more parameters of one or more components of the 3D model of the object, which may be base components of the 3D model or customizable geometry components of the 3D model.

In addition, in some implementations, a 3D print check can be performed 210 while receiving the input specifying the one or more controls. Such checks can be initiated periodically, such as at regular intervals, upon each user input to create or modify a control, or upon request by the user. The check can involve determining 220 a range of possible changes made available through the model interface in light of one or more controls for the 3D model, analyzing 230 the range of possible changes to identify 3D printing issues, and identifying 240 any potential 3D printing issues.

Thus validation of the customizable 3D model can occur while the user is creating the customizable 3D model, thus allowing the user to take corrective action with further input 200. The processes of determining 220 and analyzing 230 can involve sampling, extreme/limit testing, and failure probability prediction. In addition, in some implementations, the various sub-processes of the validation can be separated such that some run on a client computer where the customizable 3D model is being defined and some run on a server computer to which the client computer connects. Moreover, in some implementations, the validation process can involve checking for printing issues that relate to different 3D printers and different materials that can be used to print the 3D model after customization, as well as different pricing issues that arise therefrom. For example, printer and/or material metadata can be provided (e.g., as embedded values in a manner similar to how printer drivers work today for two dimensional printers) that can inform the user as to cost(s), such that, given the volume of a particular model, the material, scale, efficiency of a particular printer, etc., a user can get meaningful feedback. Thus, the user creating the customizable 3D model can be given real time feedback on the likely usability and commercial feasibility of the 3D model in view of the customization controls being added.

Once the project is completed 250, the 3D model of the object and the one or more specified controls are converted 260 into a program that runs in a publicly available runtime environment, as explained above. In some implementations, the program includes the 3D model and the one or more specified controls of the model interface. For example, a JavaScript program can be created that is downloadable to a computer and can run on that computer (e.g., in a web browser) to provide the model interface to change the 3D model in accordance with the one or more specified controls without needing to contact a server computer. In some implementations, the program includes code sufficient to initiate running the instructions effecting the 3D model and the one or more specified controls of the model interface. For example, a JavaScript program can be created that is downloadable to a computer and can run on that computer (e.g., in a web browser) to access one or more server computers to run additional program code to provide the model interface to change the 3D model in accordance with the one or more specified controls.

After conversion, the program is published 280 to an online marketplace for 3D models available for 3D printing. For example, this can involve providing the program to a web server system that hosts many such 3D models and provides online resources for a community of 3D model designers, makers, and companies. Further, in some implementations, a 3D print check can be performed 270 before publication 280 is finalized. This check can be done automatically, such as during the conversion 260, just after the conversion 260, or as part of the process of publication 280, or upon request by the user. Moreover, the validation process at publication can involve similar processes as discussed above, and validation can be performed both during creation of the customizable 3D model and during publication.

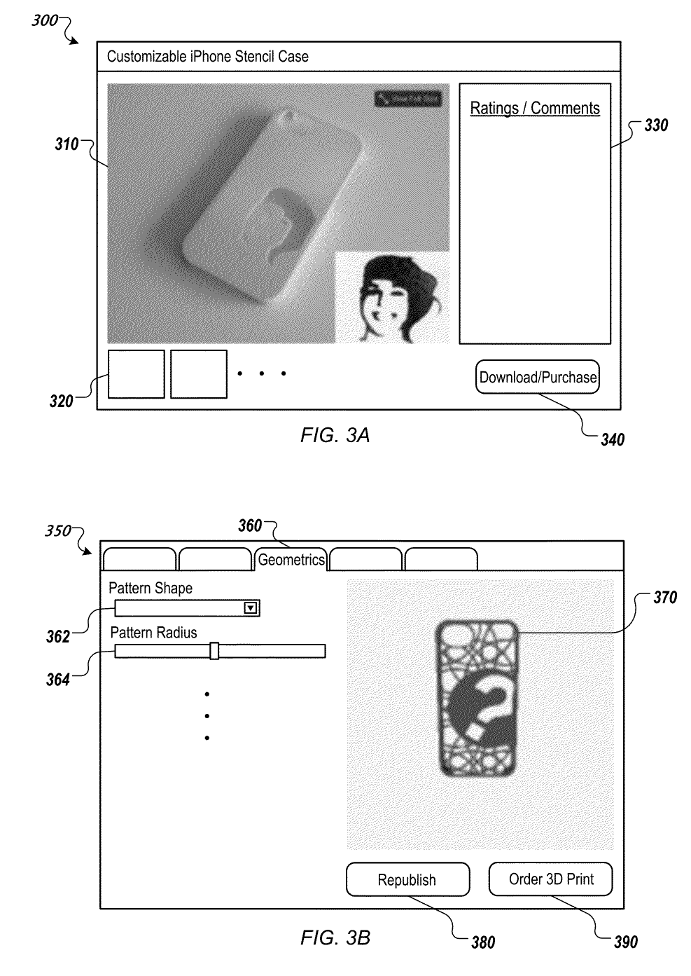

FIGS. 3A and 3B show examples of user interfaces for a customizable 3D model. In FIG. 3A, a web page 300 of an online marketplace shows a picture 310 of a 3D print of a customizable 3D model, which in this example is a customizable iPhone stencil case. The UI of the marketplace for the customizable 3D model can include various known features such as thumbnail images 320 that allow the user to select and display different views or versions of the customizable 3D model. In addition, a 3D model ratings interface 330 is provided in the web page 300, where people in the online community can leave comments about and provide ratings for a customizable 3D model.

In the example shown, the customizable iPhone stencil case includes a cutout of the 3D shape that is defined by an input, which can be a two dimensional image or a three dimensional model that is provided by the end user. The example shown in FIG. 3A shows the image of a face and the 3D print of the 3D model with the geometry of the 3D model having been modified by the image of the face. In addition, a download/purchasing button 340 is shown to represent a 3D model purchasing interface. In some implementations, the user can download and modify the 3D model before committing to a purchase, while in other implementations, the user purchases the 3D model and then has freedom to modify and print it as often as desired. In some implementations, disconnected download packaging can be automated so users can play with the functionality offline or host it on their own website.

In any case, various user interfaces can be employed for online purchasing of the program for the customizable 3D model, an order for a 3D print of the customizable 3D model, or both. FIG. 3B shows a web page 350 in which the program for the customizable 3D model is running and the model interface is presented to the user to enable customization of the 3D model. This interface can include various tabs to allow selection of a customizable feature of the 3D model, such as a geometries tab 360. Additional tabs can be provided for other types of object modification that can be done in a CAD modeling system, such as skewing, stretching, twisting the geometry, scaling or bending, or combinations of these, as well as adding patterns, such as bump maps or lattice elements. For each such tab, the interface can present separate controls that modify the 3D model's geometry, parameters, or both. For example, a file selection input interface element 362 can allow the user to select a file to use to generate the pattern shape of the cutout for the customizable iPhone stencil case, and a slider interface element 364 can allow the user to control the radius (and thus size) of the pattern being added. Other inputs can include changes to pattern overlap, pattern rotation, and pattern thickness.

The various controls of the customizable 3D model can make various changes available for the 3D model through the model interface presented in the web page 350. These can include additions to the 3D model as well as definitions of parameters for the 3D mode. In some implementations, the user can efficiently design, through a graphical user interface, application program interfaces (APIs) for geometry creators in the 3D model. In addition, the user can create geometry modifiers that add, remove or change components of the 3D model (e.g., faces in a boundary representation of the object).

As the user makes selections in the model interface, a preview 370 of the customized model can be generated and displayed in the web page 350. In addition, a 3D printing interface, such as an “Order 3D Print” button 390, can be included in the online marketplace through which users can request an order for the object of the 3D model from a 3D printing service provider after modification using the controls of the model interface. Moreover, the online marketplace for 3D models can allow republication 380 of the program with the additions made thereto. Thus, an original customizable 3D model can be used to create new products by end users with little or no experience in 3D modeling and CAD software. This can provide significant benefits in the online community for 3D models and 3D printing by opening up the field to many creative people that might not otherwise participate in creating new products using computer-based 3D modeling techniques. In some implementations, a robust versioning mechanism can be provided that allows developers to release and update code whenever they want, without adversely affecting users or requiring downtime.

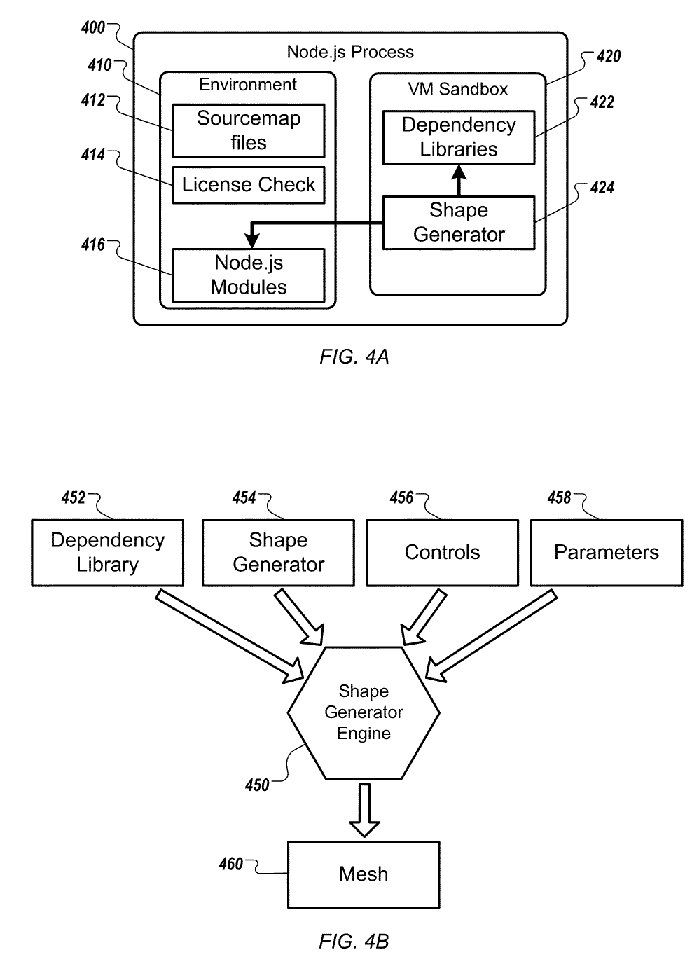

FIG. 4A shows an example of a JavaScript software architecture in which Node.js is used. This can provide advantages in terms of native support for typed arrays, facilitation of creation of a server-side execution environment that can be made essentially identical to the client-side environment when a plug-in is used, avoiding delays that can be caused by DLL (dynamic linked library) loading, simplifying maintenance, and improving script execution.

A Node.js process 400 can include an environment 410 and a virtual machine (VM) sandbox 420. The environment 410 can include sourcemap files 412, a license check module 414, and Node.js modules 416. Note that some Node.js modules 416 can be very useful, but should be permitted with caution or via access keys, e.g., using Hypertext Transfer Protocol Secure (HTTPS). In addition, the license check module 414 can be designed to provide security (e.g., prevent malicious code from accessing potentially hazardous APIs), monetization (e.g., restrict library access on a precondition that the user has paid a fee to access functionality on a per-month, per-year, per-project, or per-shape basis and is current), and end-user acknowledgement (e.g., restrict access to client-side functionality based on a grant from the end-user).

The VM sandbox 420 can be limited such that no access is provided to various system resources (e.g., the file system). As an additional security measure (on top of the license check) the execution time can be limited, such as to 10 seconds or less. The VM sandbox 420 can include dependency libraries 422 and a shape generator 424. Note that the system can be designed such that users can develop their own libraries that others can then use and leverage. Some libraries may include geometry modifiers, geometry importers and geometry exporters, and when added to a project, these would extend the capabilities of the base application with community-developed functionality. In some implementations, any community user can publish a library that contains geometry modifiers, and users can browse through available 3D model extensions, add them their the current project, and then have additional tools at their disposal for geometry modifications, allowing them to add one or more modifiers to any shape or group in a 3D model.

Note that the libraries can be automatically wrapped to support both client and server execution. Thus, the scripts (e.g., *.js files) can be used directly on the client computer for things like tools and UI, or to do shape computations, without imposing a client/server round trip. The design of the system can be such that the complexity of simultaneously designing for both client and server side execution can be concealed from the user. In addition, automated minification can be employed when generating the program from the various sources, with source mapping for original to minified versions, and documentation and licensing compliance.

FIG. 4B shows an example of code workflow. One or more dependency libraries 452, a shape generator 454, controls 456, and parameters 458 are combined in a shape generator engine 450, which operates to produce mesh 460 representing the modeled object. This can involve combining various source files (e.g., multiple *.js files) into two or more files files (e.g., a Library.js file and a Library.map file). In addition, a minification can be performed on the files (e.g., to remove comments and white space). For execution, the various program files and parameters can be processed in the shape generator engine 450 to produce the mesh 460 for display.

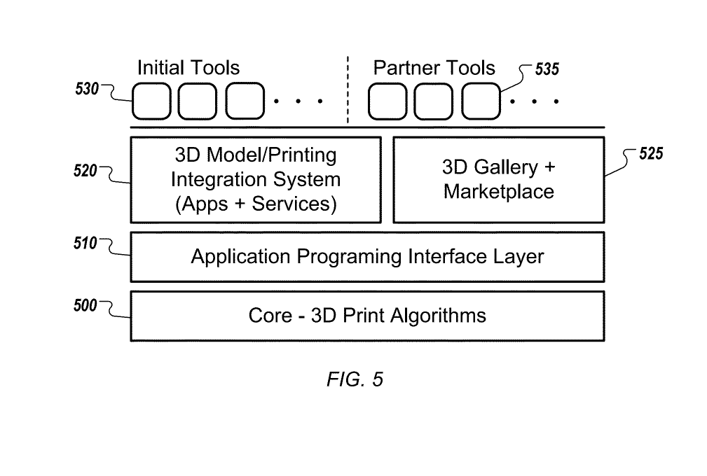

FIG. 5 shows an example of a platform architecture for an online marketplace. The platform architecture includes core 3D print algorithms 500 and an application programming interface (API) 510 through which upper layer programs are provided access to the core algorithms 500. In some implementations, the API 510 is written entirely in the same scripting language used by the program of the customizable 3D model (e.g., JavaScript). The platform architecture includes a 3D modeling and printing integration system 520, which can include both apps and services, and a 3D gallery and marketplace 525 built using web services. Additional tools, such as initial tools 530 provided for the system and partner tools 535 that can be added over time, can be built on top of the lower layers of the platform architecture.

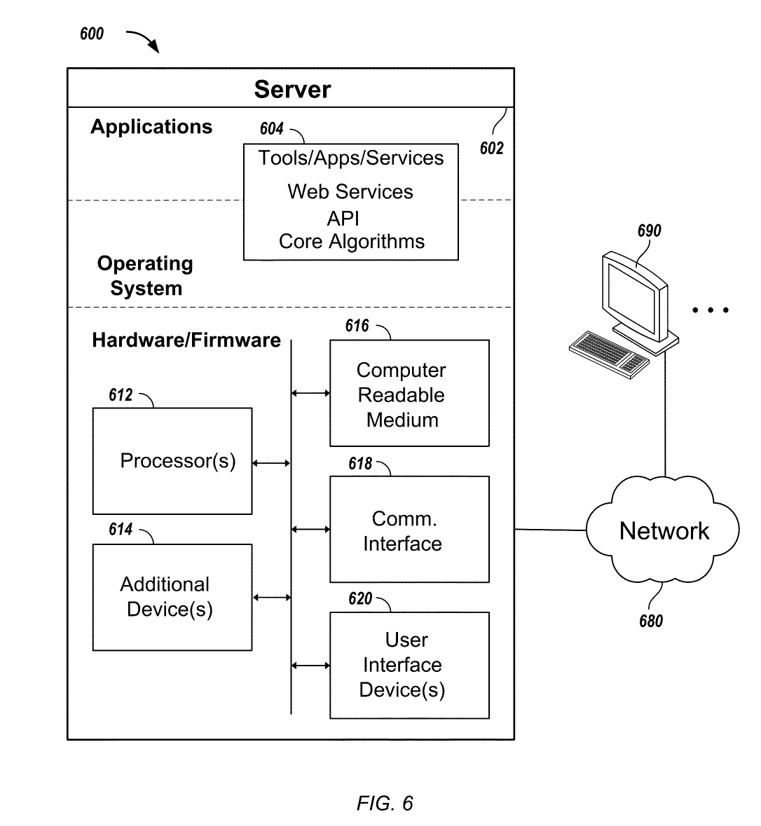

FIG. 6 is a schematic diagram of a computer system 600, which can be programmed as a client or (as shown) as a server 602. The server 602 is connected with one or more client computers 690 through a network 680. The server 602 consists of one or more data processing apparatuses. While only one data processing apparatus is shown in FIG. 6, multiple data processing apparatus can be used. The server 602 includes various software modules, which can be distributed between an applications layer and an operating system. These can include executable and/or interpretable software programs or libraries, including tools, apps, services, web services, an API, and core algorithms 604, such as described above. The number of software modules used can vary from one implementation to another. Moreover, the software modules can be distributed on one or more data processing apparatus connected by one or more computer networks or other suitable communication networks.

The server 602 also includes hardware or firmware devices including one or more processors 612, one or more additional devices 614, a computer readable medium 616, a communication interface 618, and one or more user interface devices 620. Each processor 612 is capable of processing instructions for execution within the server 602. In some implementations, the processor 612 is a single or multi-threaded processor. Each processor 612 is capable of processing instructions stored on the computer readable medium 616 or on a storage device such as one of the additional devices 614. The server 602 uses its communication interface 618 to communicate with one or more computers 690, for example, over a network 680. Examples of user interface devices 620 include a display, a camera, a speaker, a microphone, a tactile feedback device, a keyboard, and a mouse. The server 602 can store instructions that implement operations associated with the modules described above, for example, on the computer readable medium 616 or one or more additional devices 614, for example, one or more of a floppy disk device, a hard disk device, an optical disk device, a tape device, and a solid state memory device.

Embodiments of the subject matter and the functional operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented using one or more modules of computer program instructions encoded on a computer-readable medium for execution by, or to control the operation of, data processing apparatus. The computer-readable medium can be a manufactured product, such as hard drive in a computer system or an optical disc sold through retail channels, or an embedded system. The computer-readable medium can be acquired separately and later encoded with the one or more modules of computer program instructions, such as by delivery of the one or more modules of computer program instructions over a wired or wireless network. The computer-readable medium can be a machine-readable storage device, a machine-readable storage substrate, a memory device, or a combination of one or more of them.

The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, a runtime environment, or a combination of one or more of them. In addition, the apparatus can employ various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described is this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other.

While this specification contains many implementation details, these should not be construed as limitations on the scope of the invention or of what may be claimed, but rather as descriptions of features specific to particular embodiments of the invention. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the invention have been described. Other embodiments are within the scope of the following claims. For example, the embodiments are described in the context of using a boundary representation model, but other model paradigms can be used, such as constructive solid geometry (CSG) representation. As another example, although details are given for implementations using JavaScript, other scripting programming languages can also be used. In addition, the actions recited in the claims can be performed in a different order and still achieve desirable results.

What is claimed is:

1. A system comprising:
one or more computer storage media having instructions stored thereon; and
one or more data processing apparatus configured to execute the instructions to perform operations comprising (i) receiving input specifying one or more controls that modify geometry of a three dimensional (3D) model of an object, (ii) converting the 3D model of the object and the one or more specified controls into a program that runs in a publicly available runtime environment to provide a model interface to change the 3D model in accordance with the one or more specified controls when the program is run in the publicly available runtime environment, and (iii) publishing the program to an online marketplace for 3D models available for 3D printing.

2. The system of claim 1, wherein the online marketplace comprises a web server system, the publicly available runtime environment comprises a web browser, and the program comprises scripting code.

3. The system of claim 1, wherein the program includes the 3D model and the one or more specified controls of the model interface, and the online marketplace comprises:
a 3D model ratings interface through which users can provide feedback on the 3D model of the program; and
a 3D printing interface through which users can request an order for the object of the 3D model from a 3D printing service provider after modification using the one or more specified controls.

4. The system of claim 3, wherein the 3D printing interface comprises a 3D model purchasing interface through which users can pay for the program, the order, or both.

5. The system of claim 1, wherein an available change to the 3D model through the model interface includes an addition to the 3D model, and the online marketplace for 3D models allows republication of the program with the addition made thereto.

6. The system of claim 5, wherein the receiving comprises receiving input specifying one or more additional controls that modify one or more parameters of one or more components of the 3D model of the object, and the converting includes converting the one or more additional controls for the program to provide the model interface to change the 3D model in accordance with the one or more additional controls when the program is run in the publicly available runtime environment.

7. The system of claim 1, wherein the one or more data processing apparatus are configured to execute the instructions to perform operations comprising determining a range of possible changes made available through the model interface, and analyzing the range of possible changes to identify 3D printing issues.

8. The system of claim 7, wherein the determining and the analyzing are performed before finalizing publication of the program to the online marketplace.

9. The system of claim 7, wherein the determining and the analyzing are performed while receiving the input specifying the one or more controls.

10. A method comprising:
receiving, at a computer, input specifying one or more controls that modify geometry of a three dimensional (3D) model of an object;
converting the 3D model of the object and the one or more specified controls into a program that runs in a publicly available runtime environment to provide a model interface to change the 3D model in accordance with the one or more specified controls when the program is run in the publicly available runtime environment; and
publishing the program to an online marketplace for 3D models available for 3D printing.

11. The method of claim 10, wherein the online marketplace comprises a web server system, the publicly available runtime environment comprises a web browser, and the program comprises scripting code.

12. The method of claim 10, wherein the program includes the 3D model and the one or more specified controls of the model interface, and the online marketplace comprises:
a 3D model ratings interface through which users can provide feedback on the 3D model of the program; and
a 3D printing interface through which users can request an order for the object of the 3D model from a 3D printing service provider after modification using the one or more specified controls.

13. The method of claim 12, wherein the 3D printing interface comprises a 3D model purchasing interface through which users can pay for the program, the order, or both.

14. The method of claim 10, wherein an available change to the 3D model through the model interface includes an addition to the 3D model, and the online marketplace for 3D models allows republication of the program with the addition made thereto.

15. The method of claim 14, wherein the receiving comprises receiving input specifying one or more additional controls that modify one or more parameters of one or more components of the 3D model of the object, and the converting includes converting the one or more additional controls for the program to provide the model interface to change the 3D model in accordance with the one or more additional controls when the program is run in the publicly available runtime environment.

16. The method of claim 10, comprising:
determining a range of possible changes made available through the model interface; and
analyzing the range of possible changes to identify 3D printing issues.

17. The method of claim 16, wherein the determining and the analyzing are performed before finalizing publication of the program to the online marketplace.

18. The method of claim 16, wherein the determining and the analyzing are performed while receiving the input specifying the one or more controls.

19. A computer storage medium having instructions stored thereon that cause data processing apparatus to perform operations comprising:
receiving input specifying one or more controls that modify geometry of a three dimensional (3D) model of an object;
converting the 3D model of the object and the one or more specified controls into a program that runs in a publicly available runtime environment to provide a model interface to change the 3D model in accordance with the one or more specified controls when the program is run in the publicly available runtime environment; and
publishing the program to an online marketplace for 3D models available for 3D printing.

20. The computer storage medium of claim 19, the operations further comprising:
determining a range of possible changes made available through the model interface; and
analyzing the range of possible changes to identify 3D printing issues.
